(19) United States
(12) Patent Application Publication
(10) Pub. No.: US 2005/0103883 A1
(43) Pub. Date: May 19, 2005

(54) Spray gun cleaning arrangements

(76) Inventors: Joseph G. Schroeder, North Royalton, OH (US); Brian D. Mather, North Olmsted, OH (US); Jeffrey R. Shutic, Waksman, OH (US); Mark Gacka, Lakewood, OH (US)

Correspondence Address: CALFEE, HALTER & GRISWOLD, LLP, 800 SUPERIOR AVENUE, SUITE 1400, CLEVELAND, OH, 44114, US

(21) Appl. No.: 10/507,236

(22) PCT Filed: Mar. 20, 2003
(86) PCT No.: PCT/US03/08578

Related U.S. Application Data
(60) Provisional application No. 60/366,205, filed on Mar. 21, 2002.

(51) Int. Cl. B05B 1/28

(52) U.S. Cl. 239/104

(57) ABSTRACT

Apparatus and methods are provided for removing powder overspray from the exterior surfaces within a spray booth, especially the exterior surfaces of a spray gun assembly. These surfaces may include the spray gun housing and nozzle, a tube mount housing for the tube mount configurations, and in some embodiments the various hoses and lines that are coupled to the spray gun in a bar mount configuration. In one embodiment, powder overspray is removed from such surfaces or other surfaces within the spray booth by applying a cleaning or powder removal agent/article in contact with the surfaces to knock off, wipe, blow or otherwise remove the powder overspray. The cleaning agent/article may take many forms, including but not limited to fluids including air or liquid, negative pressure or suction, charged ions, positive pressure within the spray gun assembly, or any number and variety of cleaning devices such as but not limited to brushes, cloth, sponges, wipers and so on. A number of embodiments are described, including but not limited to the use of vacuum or negative pressure nozzles, negative pressure with a cleaning media, a cryogenic rinse, wiping contact articles such as rags, brushes, sponges or rubber/plastic wipers, oppositely charged particles, and air flow pressurized air from within the spray gun assembly so as to blow off or knock off the powder overspray via a flexible boot or bladder.

### RELATED APPLICATIONS

This application claims the benefit of U.S. Provisional patent application Ser. No. 60/366,205 filed on Mar. 21, 2002 for EXTERNAL CLEANING DEVICES FOR POWDER GUNS, the entire disclosure of which is fully incorporated herein by reference.

### TECHNICAL FIELD OF THE INVENTION

The present invention relates to cleaning or removing powder overspray from the exterior surfaces of a powder spray gun. More particularly, the invention relates to methods and apparatus for removing powder overspray from an exterior surface of a spray gun assembly which may include the use of pressurized air or arrangements that do not require the use of pressurized air, or a combination thereof.

### BACKGROUND OF THE INVENTION

Powder spraying systems are well known. A typical powder praying system includes a powder source, such as powder stored in a fluidizing hopper. The powder in the hopper may be fluidized using pressurized air, although not all powder spray systems use fluidized powder supplies. The spraying system also includes a powder spray device such as a spray gun that extends into a spray booth. The spray gun is used to spray powder at an object inside the booth. The spray booth is used for powder containment and recovery. Many types of spray guns have been developed over the years including electrostatic guns such as corona spray guns and tribo-charging guns. Most powder spraying systems also include a powder collection system to collect powder overspray. Some powder spraying systems use non-electrostatic spray guns. Powder overspray is any powder that does not adhere to the object being sprayed. A significant amount of powder overspray is typically produced during a spraying operation, some of which accumulates on the spray gun assembly. Spray guns typically include an outer housing or shell that encloses various components of the spray gun.

In many powder spray systems, it is desirable to be able to move a spray gun or a plurality of spray guns automatically toward and away from the object being sprayed. For example, a gun mover that is positioned outside the spray booth may be used to position spray guns into and retract spray guns from a spray booth through suitable openings in the spray booth wall structure. Known gun movers, including gun movers such as are described in U.S. Pat. No. 4,616,782 and in co-pending U.S. patent application Ser. No. 09/589,946 for PNEUMATICALLY CONTROLLED SPRAY GUN MOVER, both of which disclosures are fully incorporated herein by reference, include the capability of horizontal positioning as well as vertical positioning of one or more guns mounted on the gun mover. Vertical movement of the guns during a spraying operation is also commonly effected by an oscillator device. Spray guns are typically mounted on known gun movers via a series of vertical and horizontal gun mount bars or tubes.

Spray guns may be mounted in at least two basic configurations. The first or bar mount configuration contemplates supporting the spray gun housing on a tube, bar or other suitable structure that is part of a gun mover or support. The second or tube mount configuration contemplates supporting the spray gun by joining the spray housing to an elongated hollow support tube or housing which in turn is supported on a gun mover or other suitable structure. The support tube encloses the various lines and hoses that are connected to the spray gun, such as, for example, a powder feed tube, electrical cable and air hose. The tube mount configuration allows a spray gun to be positioned inside a spray booth without powder overspray collecting on the various lines and hoses as well as allowing the gun mover or support structure to be positioned outside the spray booth. The spray gun and associated support tube are positioned inside the spray booth by moving them through one or more gun slots in a spray booth wall. Gun slots typically are vertically extending openings in the spray booth walls to allow horizontal and vertical positioning and movement of the guns.

Powder spray guns, especially electrostatic spray guns, tend to collect powder overspray on their exterior gun surfaces. This powder must be removed if the powder color is to be changed. A complete color change procedure can be slowed down by having a large number of surfaces to be cleaned inside the spray booth and on the gun bodies. Known powder spraying systems include air nozzles positioned near a spray gun to blow powder off the gun body. This can be accomplished, for example, as the guns are retracted from the booth by the gun mover. However, known systems are limited in that the air nozzles are fixed in position or otherwise not easily adjusted, and cannot be repeatedly positioned at a predetermined location relative to the gun position. Gun positions may be changed, for example, depending on the object being sprayed.

With reference to FIGS. 1 and 2, typical prior art powder spraying system 10 configurations are illustrated. The illustrations of FIGS. 1-2 are simplified in order to explain a typical application to which the present invention may be applied. The system 10 gun mount components illustrated in FIGS. 1-2 are well known.

The spray system 10 typically includes a spray booth 12 that partially encloses an object A being sprayed. The spray booth 12 may include a powder collection system 14 to recover powder overspray. A powder feed hopper 16 holds a supply of powder coating material that is fed to one or more spray gun assemblies 18 via powder feed lines 20. The spray gun assemblies 18 spray the object A non-electrostatically or with an electrostatically charged powder spray 22.

Known spray systems 10 often incorporate the use of a gun mover 30. The gun mover 30 includes a base 32 that supports a movable platform 34. A gun support 36 is vertically mounted on the movable platform 34. In the prior art, the gun support 36 is a fixed gun support that includes a number of horizontal support arms 37 that are mounted to a fixed stand 40. A number of vertical mounting bars 39 are attached to the horizontal support arms 37. Horizontal gun mount bars 38 to which the spray guns 18 are removably attached as by any conventional clamp assembly, for example, may also be used. The spray guns 18 may also be mounted directly to the vertical bars 39. The fixed stand 40 is generally vertically oriented and securely mounted on the movable platform 34. By “fixed” is simply meant that the guns 18 are moved only by the mover 30, in a single direction parallel with the translation axis of the platform 34 as denoted by the directional arrow B in FIG. 1. The stand 40 may also be a gun oscillator, as is known in the art. Such an oscillator imparts vertical position control and movement to the guns attached to the oscillator, thus allowing vertical and horizontal position control of the guns 18.

The gun mover 30 further includes a control system 42 for programmable control of the position of the guns 18. The control system 42 includes a control device 44. The control device 44 may be used to control position of the guns in the spray booth, operation of the oscillator, and operation of the spray guns.

FIG. 1. illustrates a typical tube mount configuration as described above, wherein each spray gun assembly 18 includes a spray gun housing 18a installed on or supported by a tube mount housing 18b. FIG. 2 illustrates a typical bar mount assembly in which each spray gun housing 18a is supported on a gun mount bar or tube 38.

The present invention is directed to methods and apparatus for facilitating powder overspray removal from the spray gun assemblies including the spray gun housing and tube mount housing when used.

### SUMMARY OF THE INVENTION

The present invention contemplates a variety of apparatus and methods for removing powder overspray from the exterior surfaces within a spray booth, especially the exterior surfaces of a spray gun assembly. These surfaces may include the spray gun housing and nozzle, a tube mount housing for the tube mount configurations, and in some embodiments the various hoses and lines that are coupled to the spray gun in a bar mount configuration. In accordance with one aspect of the invention, powder overspray is removed from such surfaces or other surfaces within the spray booth by applying a cleaning or powder removal agent/article in contact with the surfaces to knock off, wipe, blow or otherwise remove the powder overspray. In accordance with another aspect of the invention, various embodiments may be used to remove powder overspray from surfaces other than those surfaces directly associated with a spray gun, such as spray booth walls, gun mover/support structures and so on, but the invention finds particular application in removing powder overspray from the spray gun assemblies and related components.

In further accordance with the invention, the cleaning agent/article may take many forms, including but not limited to fluids including air or liquid, negative pressure, charged ions, positive pressure from within the spray gun assembly, or any number and variety of cleaning devices such as but not limited to brushes, cloth, sponges, wipers and so on. The various cleaning agents may be used individually or in any desired number of combinations.

A number of embodiments are described herein, including but not limited to the use of vacuum or negative pressure nozzles, negative pressure with a cleaning media, a cryogenic rinse, wiping contact articles such as rags, brushes, sponges or rubber/plastic wipers, oppositely charged particles, and air flow or pressurized air from within the spray gun assembly so as to blow off or knock off the powder overspray.

The invention is thus directed to removing powder overspray from exterior surfaces using methods and apparatus that do not require, although may be used with, an external air flow impinging on the surfaces to be cleaned, such as the use of external pressurized air nozzles that blow powder from the surfaces.

These and other aspects and advantages of the present invention will be apparent to those skilled in the art from the following description of the preferred embodiments in view of the accompanying drawings.

### BRIEF DESCRIPTION OF THE DRAWINGS

The invention may take physical form in certain parts and arrangements of parts, preferred embodiments and methods of which will be described in detail in this specification and illustrated in the accompanying drawings which form a part hereof, and wherein:

FIGS. 1 and 2 illustrate in side, back elevations and perspective views respectively typical prior art powder spray system configurations;

FIG. 3 is a top view of a prior art spray gun cleaning arrangement using positive air pressure;

FIG. 4 illustrates alternative embodiments for removing powder using negative pressure;

FIG. 5 illustrates an alternative embodiment for removing powder overspray using wiping or contact devices;

FIGS. 6a and 6b illustrate more alternative embodiments for removing powder overspray using cryogenic fluid or oppositely charged particles;

FIG. 7 illustrates another embodiment for removing powder overspray from a spray gun using a porous gun housing;

FIGS. 8a and 8b illustrates in elevation and front end views respectively an alternative embodiment for removing powder overspray utilizing a flexible boot with a spray gun housing for a tube mount configuration; and

FIG. 9 illustrates alternative embodiment for removing powder overspray utilizing a flexible boot with a spray gun housing for a bar mount configuration.

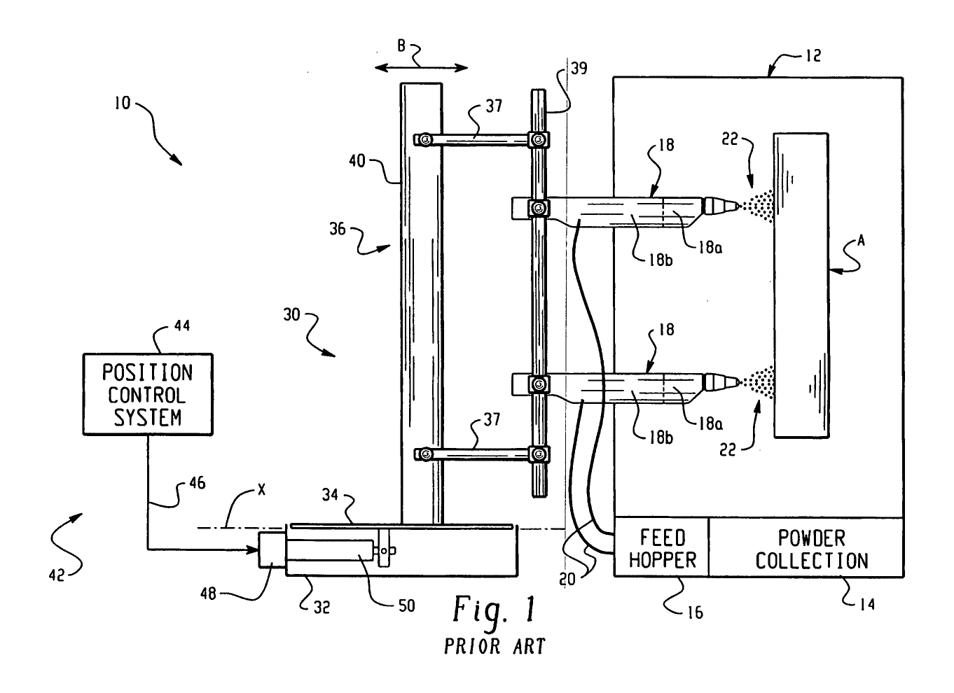

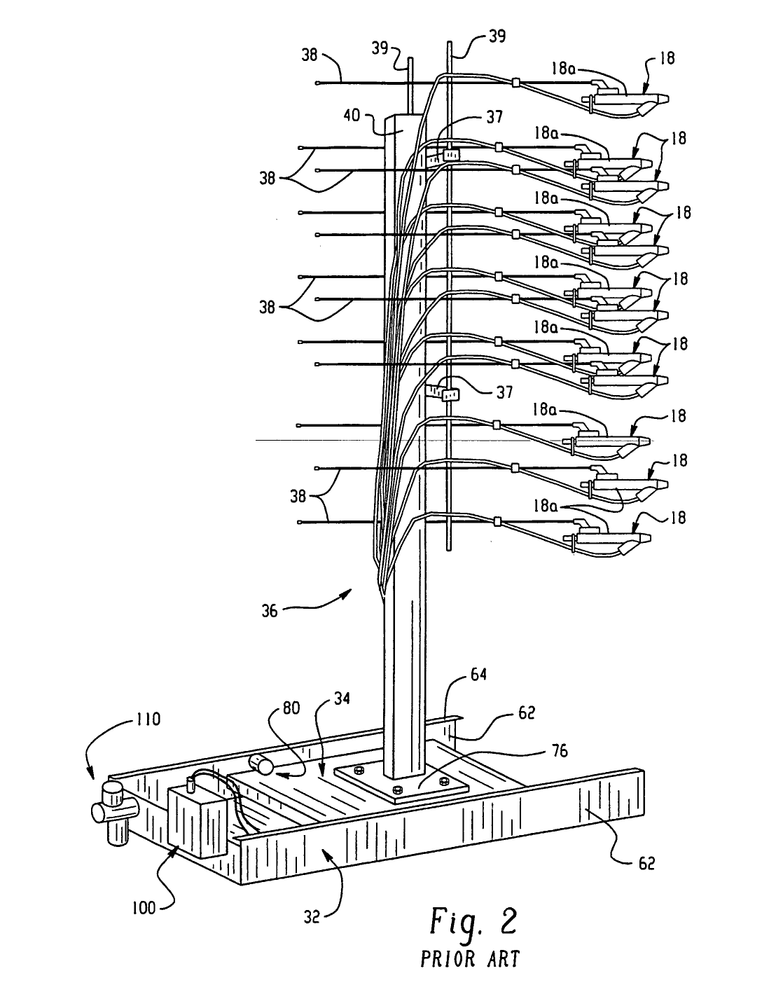

### DETAILED DESCRIPTION OF THE INVENTION

The present invention is directed to methods and apparatus for removing powder overspray from external surfaces, such as, but not necessarily limited to, external surfaces of a spray gun assembly, by the use of a cleaning agent that operates other than by the application of an external air flow across or impinging on the surface to be cleaned. These aspects if required may be used in combination with external blow off techniques as well.

Various aspects and embodiments of the present invention are illustrated and described herein as being used together, however, such description should not be construed in a limiting sense. Those skilled in the art will readily appreciate that various aspects of the invention may be used alone or in a number of different combinations and sub-combinations thereof within the spirit and scope of the present invention. Furthermore, although various preferred and alternative embodiments of the invention are described herein, such descriptions are not intended to be an exhaustive list of such alternatives and options. Additional alternatives and modifications will be readily apparent to those skilled in the art within the spirit and scope of the present invention.

While the present invention is described in terms of being incorporated into or used with specific elements of a powder spraying apparatus, the present invention is not limited to such descriptions or uses. For example, the invention may be used with different gun supports or gun movers. The present invention is also not limited to any particular spray gun, gun mounting arrangement, or spray booth configuration or design or spraying technology. For example, the present invention may be used with electrostatic and non-electrostatic spraying techniques and need not be used exclusively with powder spraying apparatus.

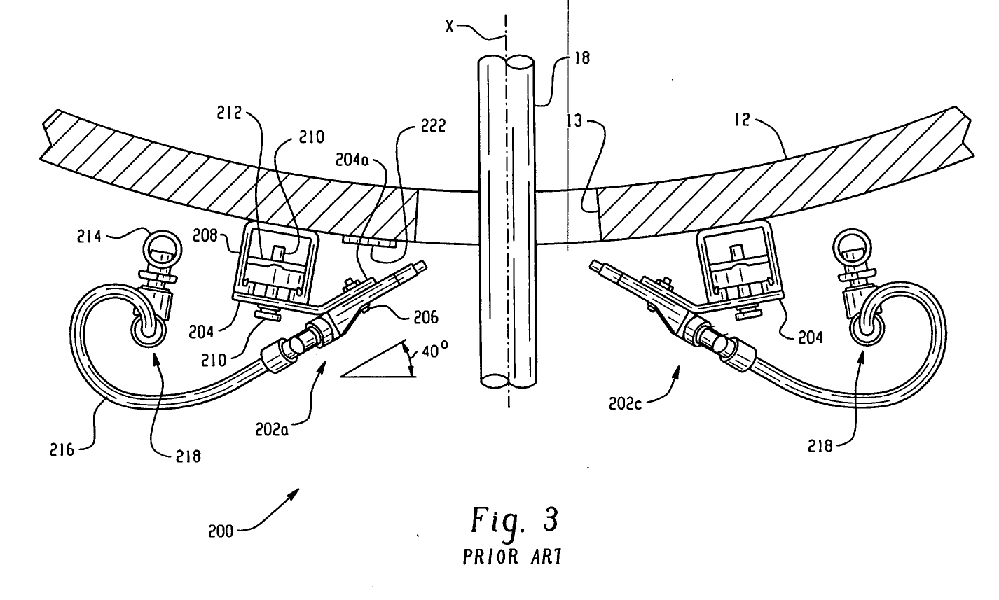

With reference to FIG. 3, a known powder spray gun blow off design and mounting arrangement using positive pressure is illustrated. This blow off arrangement may be used in combination with various of the spray gun cleaning arrangements of the present invention to provide improved gun cleaning operations and hence faster color change operations. However, the various aspects of the present invention may also be used without a positive pressure cleaning arrangement. The structure of FIG. 3 is provided for illustrating in an exemplary manner a suitable but not exclusive mounting arrangement for the gun cleaning techniques of the present invention.

Each gun blow off mounting arrangement 200 includes one or more air nozzles 202 (in FIG. 3 there are two nozzles shown, 202a and 202c) positioned as required to direct pressurized air at an exterior surface of the associated spray gun 18 (the gun is schematically illustrated in phantom in FIG. 3). The air nozzles 202 are mounted on a respective side of the spray gun 18 relative to a horizontal central axis X of a gun slot or opening 13 in a wall of a spray booth 12.

The nozzles 202 are mounted on a nozzle mounting bracket 204. The nozzle mounting bracket 204 includes an angled flange 204a that carries the nozzles 202. Each nozzle 202 is pivotally attached to the mounting bracket flange 204a by a screw and nut arrangement 206. The optional pivoted attachment is useful for adjusting the angle of the nozzle 202 towards the spray gun 18. In the exemplary design of FIG. 3, the angle is about 40°.

The nozzle mounting bracket 204 is mounted on a support channel 208. The channel 208 permits sliding movement of the bracket 204 along a portion of the channel 208 to permit vertical adjustment of the position of the air nozzles 202 relative to the spray gun 18. Once the nozzle position has been selected, the bracket 204 is releaseably joined to the channel 208 using thumb screws 210. The thumb screws 210 cooperate with a clamping member 212 such as a channel nut that is disposed inside the channel 208. When the thumb screws 210 are tightened, the clamping member 212 is pulled up against the channel legs to clamp the flange 204 against the channel 208. Simply loosening the thumb screws 210 allows the flange 204 to be moved to another position along the channel 208.

A pressurized air manifold 214 extends vertically (through the plane of the drawing as viewed in FIG. 3) and generally parallel to the channel 208. The air manifold 214 may be attached, for example, to the channel 208 or as another example, spray booth 12 wall. Pressurized air is supplied to the manifold 214 by any suitable fitting (not shown). The channel 208 likewise may be attached to the spray booth wall, for example.

Each air nozzle 202 is coupled to the air manifold 214 via a flexible air hose 216 and a suitable fitting or connector 218. Each air hose 216 is connected at one end to its respective air nozzle and at an opposite end to the air manifold 214. Other suitable connection arrangements may alternatively be used as required to couple each nozzle 202 to the air manifold 214.

As an alternative to the prior art use of an external pressurized air flow to blow powder overspray from the spray gun during retraction, the present invention contemplates techniques for removing powder overspray that may be used during gun retraction from the spray booth, while others may be conveniently used with the spray gun assembly positioned within the spray booth.

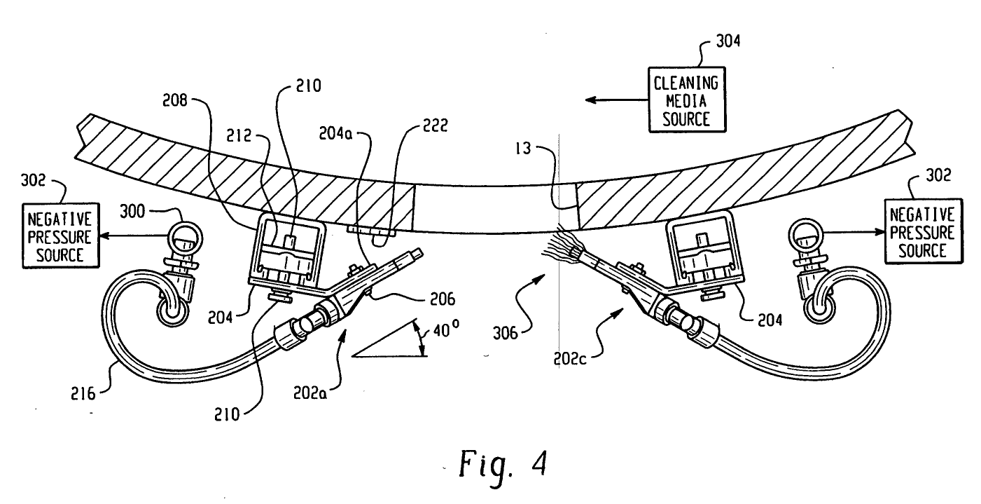

With reference to FIG. 4, in accordance with one aspect of the invention, negative pressure or vacuum may be used as a cleaning agent to remove powder from a spray gun assembly as the spray gun assembly is retracted from the spray booth. In the embodiment of FIG. 4, most of the components are given the same reference numerals as the embodiment of FIG. 3 because the structure may be the same and the description thereof need not be repeated.

However, in the embodiment of FIG. 4, each vertically extending manifold 300, which is in fluid communication with its associated nozzle 202, is connected to a negative pressure source 302, such as a vacuum pump or air blower (not shown). The negative pressure produces a suction effect at the nozzle 202 tip that draws powder off the spray gun 18 exterior surfaces. Many different nozzle shapes may be used and the nozzle tips may be positioned very close to or in contact with the surface being cleaned. Additional nozzles may be used as required and appropriately positioned about the gun slot 13 to optimize powder overspray removal.

In addition to the use of a vacuum or negative pressure, a cleaning media 304 may alternatively be introduced into the spray booth 12 interior, especially in the vicinity of the spray gun. The cleaning media may be blown or dropped in for example. Such cleaning media may be in the form of objects that add physical abrasion along with the air flow or suction from the nozzles 202. For example but not by way of limitation, the cleaning media may include soft plastic beads or pieces of foam. The media eventually is separated from the air in the suitable filter (not shown) associated with the negative pressure source 302.

In still a further alternative, brushes 306 or other suitable wiping devices may be attached to the ends of the nozzles 202 (only one is shown for clarity in FIG. 4). The brush or wiping device can assist in dislodging powder particles that the negative pressure might not otherwise remove from the surface being cleaned. The negative pressure will capture most or all of these dislodged powder particles. The brushes or wiping devices 306 may include a suitable motor (not shown) that spins or oscillates the device 306 if so required for additional abrasive action. An air motor would be particularly convenient but not an exclusive option.

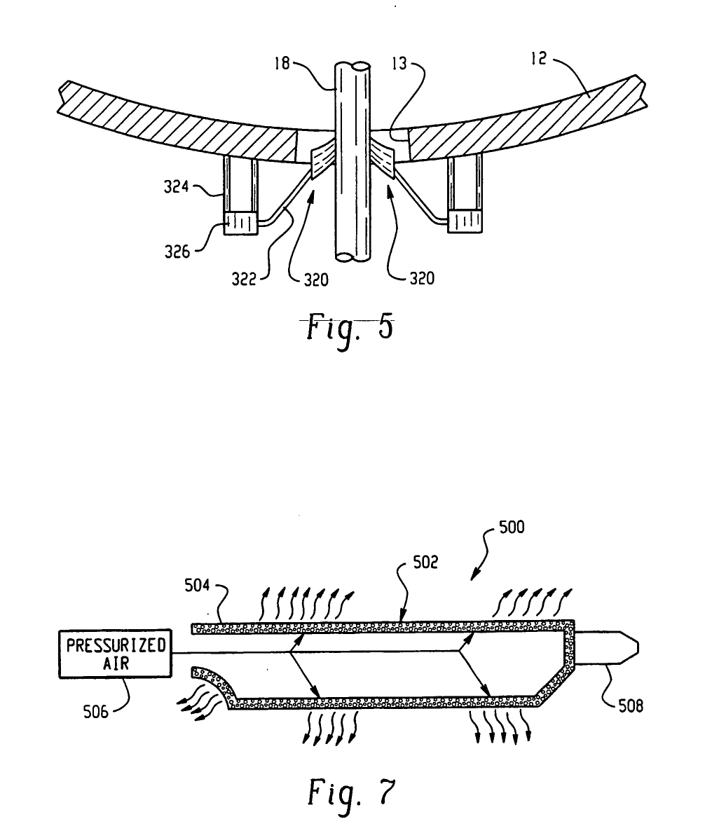

FIG. 5 illustrates another embodiment which utilizes one or more contact devices 320 as the cleaning agent. The contact device 320 typically will remove powder overspray from the spray gun assembly 18 as the gun assembly 18 is retracted from the spray booth 12 through the gun slot 13. The contact devices 320 may take any number of a wide variety of form, shapes, sizes and quantity. The contact devices 320 may for example be sponges or sponge-like, rubber or plastic wipers or squeegees, cloth, fabric or other soft material (including soft plastics or rubber) brushes, rags and so on, much like a “car wash” for the guns. The contact devices 320 are mounted on a support 322 that may, for example, allow for pivoting the devices 320 toward and away from the guns. The supports 322 are mounted on a suitable frame 324 that may be attached to the spray booth wall or separately supported. An optional motor or other suitable device 326 may be used to spin, oscillate, rotate or horizontally or vertically translate the contact devices 320 to increase abrasive action. Various combinations of devices 320 types may be used together is required and may be used with either a positive or negative pressure source proximate thereto (not shown) such as nozzles 202 described herein above.

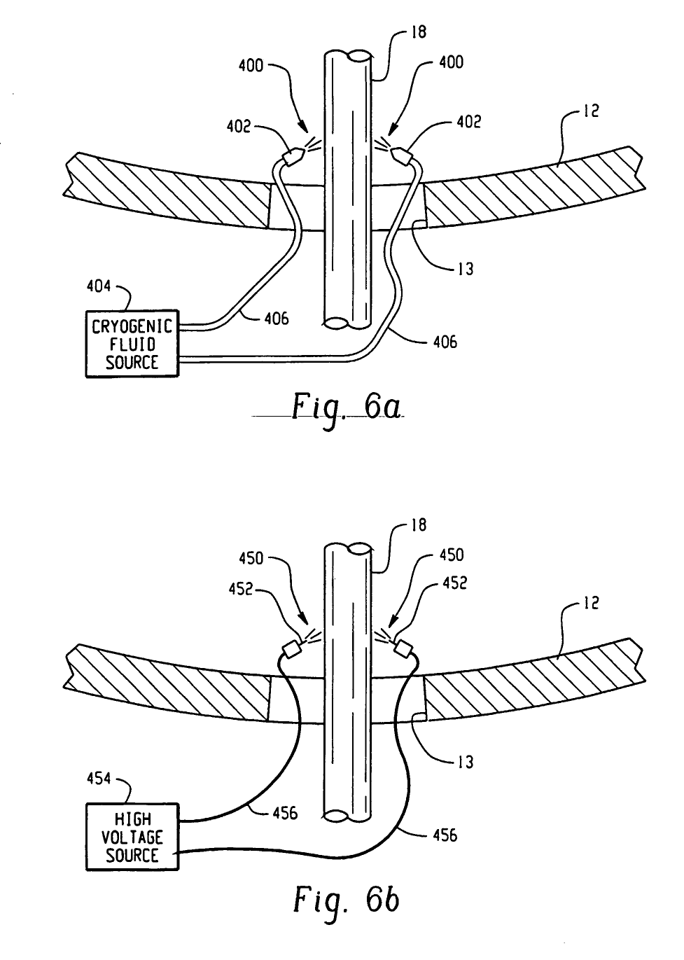

With reference to FIG. 6a, a cleaning agent in the form of a cryogenic fluid 400 is used. One or more suitable injectors or nozzles 402 is positioned near the surface to be cleaned such as the spray gun assembly 18. The nozzles 402 receive a cryogenic fluid from a cryogenic fluid source 404 through a suitable hose or conduit 406. The cryogenic fluid 400 may be, for example, liquid carbon dioxide. When the cryogenic fluid 400 contacts the powder overspray on the surface being cleaned, the super cooled powder particles will fall off the surface due to increased mass. The cryogenic fluid evaporates quickly as it heats up leaving no residue. Cryogenic fluid also would assist in dissipating electrostatic charge on the powder particles in electrostatic applications. The cryogenic fluid optionally may be sprayed with the spray gun inside the spray booth or as it is retracted. Furthermore, cryogenic fluids may be used to clean additional interior surfaces at the spray booth including but not limited to walls, doors, ducts and so on.

FIG. 6b illustrates an alternative embodiment in which charged particles 450 may be sprayed at the surface being cleaned. The embodiment is especially but not exclusively useful in electrostatic spraying technologies. A suitable ion injector 452 such as, for example, a high voltage electrode is coupled to a high voltage powder supply 454 via a suitable cable 456. The sprayed ions or charged particles 450 should be oppositely charged from the electrostatic polarity of the powder overspray. The sprayed charges 450 will dissipate the electrostatic charge on the powder overspray thus causing the powder to drop off the surface being cleaned. As in the cryogenic rinse embodiment, charged particles may be used to clean surfaces with the spray gun 18 inside the spray booth 12 or as it is retracted from the spray booth. The charged particles 450 may likewise be used to remove powder from other surfaces within the spray booth.

The charged particles and cryogenic rinse embodiments may find particular application for bar mount configurations to remove powder from difficult structures such as powder feed tubes, cable and wires for example. Moreover, removal of the powder may be further enhanced by also shaking or vibrating the spray gun either during or after application of the cryogenic rinse or oppositely charged particles. Such vibration or shaking may also be used as required in the other embodiments described herein.

The present invention further contemplates the various associated methods for removing powder overspray embodied in the use or process of the various embodiments described herein.

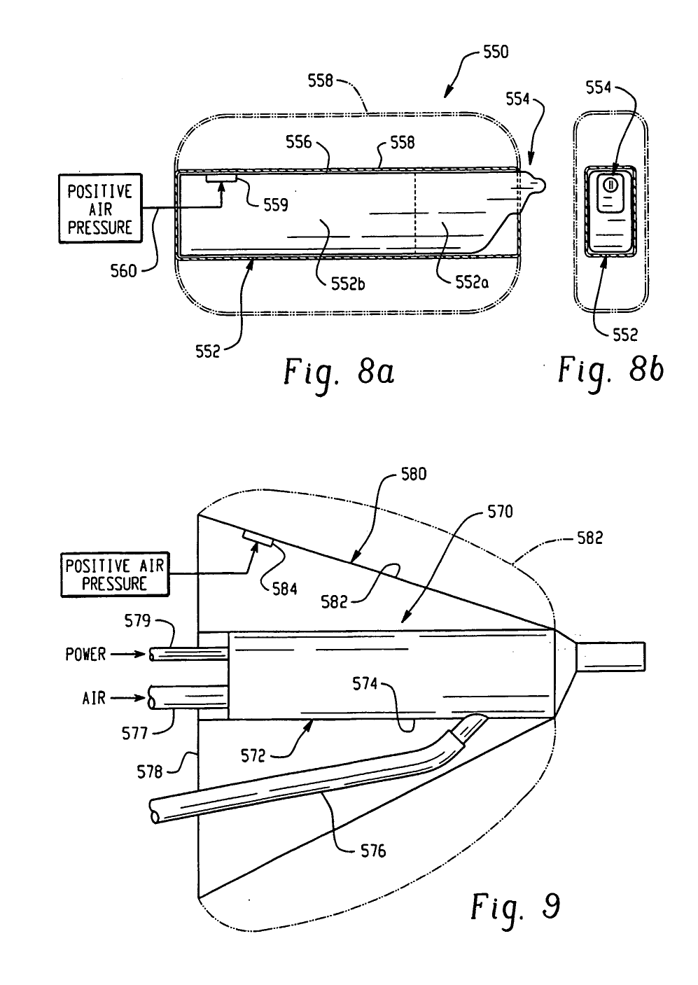

FIGS. 7 and 8a/8b illustrate additional alternative embodiments of the invention. In accordance with another aspect of the invention, pressurized air is provided internally to the spray gun housing in order to remove powder overspray from exterior surfaces of the spray gun housing and tube mount extensions when the latter are used. This is in contrast to the use of an external flow of air directed against the gun exterior to blow powder off the gun.

In FIG. 7, a spray gun 500 includes an outer housing or shell 502. The housing 502 includes an outer surface 504 on which powder overspray may collect. The spray gun 500 may be electrostatic (corona or tribocharge) or may be non-electrostatic. In one embodiment, the shell or housing 502 is made of porous material (represented by the dots in FIG. 7) that allows air to pass through while at the same time being rigid enough to support the spray gun internal components. An exemplary material is porous polyethylene available from GenPore. Such a material is commonly used as a fluidizing bed in feed hoppers. Other porous materials may alternatively be used or other structures that allow pressurized air to flow from within the spray gun to the outside surface to clean the surface or prevent powder overspray from alighting thereon.

Pressurized air 506 is applied through the porous housing 502 as represented by the directional arrows. For example, the housing 502 may include an air passageway (not shown) adjacent the porous shell 502. The pressurized air 506 may be used during a spraying operation so that powder overspray is blown away from the spray gun 500 and does not alight thereon. Alternatively, the pressurized air 506 may be applied after a spray operation to blow powder away from the gun 500. The pressurized air 506 may be received via an air hose (not shown) or otherwise internally generated. If appropriate, the nozzle 508 may also be made of a porous material.

In another embodiment illustrated in FIGS. 8a and 8b, a spray gun assembly 550 includes an outer housing or shell 552. The housing 552 may include a spray gun section 552a and a tube extension 552b as described hereinbefore for a tube mount configuration. The housing 552 supports a nozzle assembly 554. The housing 552 includes an outer surface 556. A flexible material such as latex, EPDM, rubber and so on, is provided in the form of a flexible bladder or boot 558 that coextends along the surface 556 of the housing 552. Thus in the unexpanded state the boot 558 may conform to the general outer profile of the gun assembly 550. In some applications the boot 558 may simply loosely slide over the spray gun assembly 550 or otherwise not be closely conforming. In either case, pressurized air 560 is provided to the boot 558 through a suitable fitting 559 or other connection, and is used in a pulsed or discontinuous manner to rapidly expand the boot 558 thereby knocking powder there from. In the figures, the material 558 is illustrated in an expanded position using dashed lines, and otherwise contracts back about the assembly when the pressurized air is removed. Although FIGS. 8a and 8b illustrate a tube mount configuration, those skilled in the art will appreciate that the invention may be applied to many different spray gun configurations and mounting arrangements therefore.

FIG. 9 illustrates an exemplary embodiment of an expandable boot or bladder with a spray gun assembly 570 in a bar mount configuration. Again, the spray gun assembly 570 includes a gun housing 572 having an outer surface 574 to be kept clean from powder overspray. In the bar mount configuration there may also be a powder hose 576 and other lines and hoses such as an air hose 577 or an electrical cable 579 as is known. In this case, the back end of the gun housing 572 includes a bulkhead 578 that supports or is integral with an enclosing shroud 580. The shroud 580 extends rearward as far as desired to keep powder overspray off of various spray gun related components and the gun mounting arrangement (not shown). The shroud 580 includes an outer boot or bladder 582 that may generally conform to the outer surface of the shroud 580 or simply slip on over the shroud 580. Pressurized air 560 may be supplied to the boot 582 through a suitable fitting or other connection 584, and is used in a pulsed or discontinuous manner to rapidly expand the boot 580 thereby knocking powder there from.

The embodiments of FIGS. 7, 8a/8b and 9 utilize positive air pressure to remove or prevent powder from surfaces, however, this aspect of the invention differs significantly from the prior art in that the pressurized air is initially provided internal to the gun assembly rather than being applied externally to blow powder from the surfaces.

The invention has been described with reference to the preferred embodiment. Modifications and alterations will occur to others upon a reading and understanding of this specification. It is intended to include all such modifications and alterations insofar as they come within the scope of the appended claims or the equivalents thereof.

1. Apparatus for removing powder overspray from a powder spray gun assembly used in a powder spray application system, comprising:
at least one cleaning device that can be positioned with respect to an exterior surface of a spray gun to remove powder from the spray gun;
said at least one cleaning device being in fluid communication with a source of negative pressure.

2. The apparatus of claim 1 wherein said cleaning device comprises a nozzle that sucks powder off of said exterior surface.

3. The apparatus of claim 1 comprising contact bodies that impact said exterior surface to assist in removing powder overspray there from.

4. The apparatus of claim 3 wherein said contact bodies comprise lightweight objects that are collected by said at least one cleaning device.

5. The apparatus of claim 3 wherein said contact bodies comprise wiping elements.

6. The apparatus of claim 5 wherein said wiping elements comprise brushes.

7. The apparatus of claim 5 wherein said wiping elements are rotatable.

8. Apparatus for removing powder overspray from a powder spray gun assembly used in a powder spray application system, comprising:
at least one cleaning device positioned in contact with an exterior surface of a spray gun to remove powder from the spray gun as the spray gun translates along an axis by brushing or wiping powder there from.

9. The apparatus of claim 8 comprising a negative pressure source associated with said cleaning device to capture powder removed from said exterior surface.

10. The apparatus of claim 8 wherein said cleaning device comprises a rotatable brush-like element.

11. Apparatus for removing powder overspray from a powder spray gun assembly used in a powder spray application system, comprising:
at least one cleaning agent positioned in contact with an exterior surface of a spray gun to remove powder from the spray gun; said cleaning agent comprising a cryogenic fluid.

12. The apparatus of claim 11 wherein said cryogenic fluid comprises liquid CO₂.

13. The apparatus of claim 11 comprising at least one nozzle for spraying said cryogenic fluid at said exterior surface.

14. Apparatus for removing powder overspray from a powder spray gun assembly used in a powder spray application system, comprising:
at least one cleaning agent positioned in contact with an exterior surface of a spray gun to remove powder from the spray gun; said cleaning agent comprising charged particles.

15. The apparatus of claim 14 comprising a high voltage electrode positioned near said exterior surface to direct charged particles towards said exterior surface.

16. Apparatus for removing or preventing powder overspray on an exterior surface of a powder spray gun, comprising:
a powder spray gun having an external housing that supports spray gun components therein;
said external housing comprising porous material that permits air to pass therethrough; and
a pressurized air source in fluid communication with said external housing to direct air from within said housing outward through said porous material.

17. The apparatus of claim 16 wherein said porous material comprises porous polyethylene

18. Apparatus for removing powder overspray on an exterior surface of a powder spray gun, comprising:
a powder spray gun having an external housing having that supports spray gun components therein; said external housing having an exterior surface;
said external housing comprising flexible material that expands with pressurized air; and
a pressurized air source in fluid communication with said flexible material to knock powder from said exterior surface.

19. The apparatus of claim 18 wherein said external housing comprises a flexible bladder that forms said exterior surface.

20. The apparatus of claim 18 wherein said pressurized air source produces pulsed air.

21. A method for removing powder overspray from a powder spray gun, comprising the steps of:
producing a negative pressure;
introducing said negative pressure proximate an exterior surface of a spray gun to remove powder from an exterior surface thereof.

22. The method of claim 21 comprising the step of applying an abrasive force to said exterior surface while applying said negative pressure.

23. A method for removing powder overspray from a powder spray gun, comprising the steps of:
contacting an exterior surface of a powder spray gun with a cleaning device during translational movement of the spray gun.

24. The method of claim 23 comprising the step of rotating said cleaning device.

25. A method for removing powder overspray from a powder spray gun, comprising the steps of:
applying a cryogenic fluid to an exterior surface of a powder spray gun.

26. A method for removing powder overspray from a powder spray gun, comprising the steps of:
applying charged particles to an exterior surface of a powder spray gun.

27. The method of claim 26 comprising the step of positioning a high voltage electrode near said exterior surface.

28. A method for removing powder overspray from a powder spray gun, comprising the steps of:
producing positive pressurized air;
applying said pressurized air from within a spray gun housing and through a housing wall.

29. The method of claim 28 wherein said housing wall comprises a porous material.

30. A method for removing powder overspray from a powder spray gun, comprising the steps of:
producing positive pressurized air and supplying said pressurized air within a spray gun housing; and
applying said pressurized air from within a spray gun housing against a flexible member associated with a housing wall to remove powder on an external surface thereof.
